(19) United States
(12) Patent Application Publication
(10) Pub. No.: US 2002/0166724 A1
(43) Pub. Date: Nov. 14, 2002

(54) Ladder bucket holder

(76) Inventor: Kevin L. Kvam, Chanhassen, MN (US)

Correspondence Address: BRIGGS AND MORGAN, P.A., 2400 IDS CENTER, MINNEAPOLIS, MN, 55402, US

(21) Appl. No.: 09/854,808

(22) Filed: May 14, 2001

(51) Int. Cl. E06C 5/32

(52) U.S. Cl. 182/129

(57) ABSTRACT

An apparatus for attachment to the rungs of a ladder to securely hold a bucket and other accessories. The apparatus is readily detachable from the ladder rungs for movement along the ladder. The apparatus includes engagement members for gripping the ladder rungs and a spring for biasing the engagement members against the ladder rungs. The apparatus may have a pivotable arm to which a variety of accessories may be attached.

### BACKGROUND OF THE INVENTION

The present application relates to a device adapted to be removably and securely attached between the rungs of a ladder, in order to hold a bucket or other object.

A number of U.S. Patents disclose devices for attaching to ladders in order to support buckets. Such devices generally fall into two types.

A first type is attached to the rail of the ladder, as illustrated in U.S. Pat. Nos. D313,169; 4,776,550; and 5,305,977. These devices share a common deficiency in that the device cannot be easily moved up the ladder as the painter climbs the ladder without completely detaching the device from the rail, because the ladder rungs prevent movement of the device along the rail.

A second type is attached to a rung of the ladder, as illustrated in U.S. Pat. Nos. D266,964; D393,413; 3,895,772; 5,305,977; and 5,716,034. However, with the exception of U.S. Pat. No. 5,305,977, these patents do not disclose a means for securely attaching the bucket to the ladder rung, i.e., they all rely on gravity to keep the bucket attached to the rung. U.S. Pat. No. 5,305,977 discloses a hook for engaging a ladder rung and a spring for securing the hook in place; however, the design would allow the hook to rotate around the rung under the moment of inertia of the paint bucket.

There is a need for a device that can be easily attached to a ladder to hold a bucket and other attachments, that can be secured in place, and that can be easily removed from the ladder to move along the ladder with the painter or other person climbing the ladder.

### SUMMARY OF THE INVENTION

Apparatus for attachment to the rungs of a ladder for securely holding a bucket and other accessories, the apparatus being readily detachable from the ladder rungs for movement along the ladder, the apparatus comprising:

a) a first engagement member adapted to engage a ladder rung;

b) a second engagement member adapted to engage an adjacent ladder rung; and

c) a spring biasing the first engagement member and second engagement member against the respective ladder rungs.

A principal object and advantage of the present invention is that is securely attachable to each of two adjacent rungs of a ladder, and therefore cannot move either vertically or horizontally.

Another principle object and advantage of the present invention is that it is easily detachable from the ladder rungs so that the person climbing the ladder may move the apparatus to ladder rungs further up the ladder.

Another principle object and advantage of the present invention is that it is spring-biased between adjacent ladder rungs in such a way that it can be removed and moved along the ladder with only one hand.

Another object and advantage of the present invention is that it may include a pivoting arm which can be used to attach a variety of accessories, such as a bucket holder, bucket, hook, and gripper.

### BRIEF DESCRIPTION OF THE DRAWINGS

FIG. 1 is a perspective view of a ladder with a first embodiment of the invention attached thereto.

FIG. 2 is the same as FIG. 1, but with a second embodiment of the invention attached thereto.

FIG. 3 is a perspective view of a first embodiment of the invention, with ladder rungs shown in phantom.

FIG. 4 is a perspective view of a second embodiment of the invention, with ladder rungs shown in phantom.

FIGS. 5a-5d are perspective views of various accessories that may be part of the invention.

### DETAILED DESCRIPTION OF THE PREFERRED EMBODIMENT

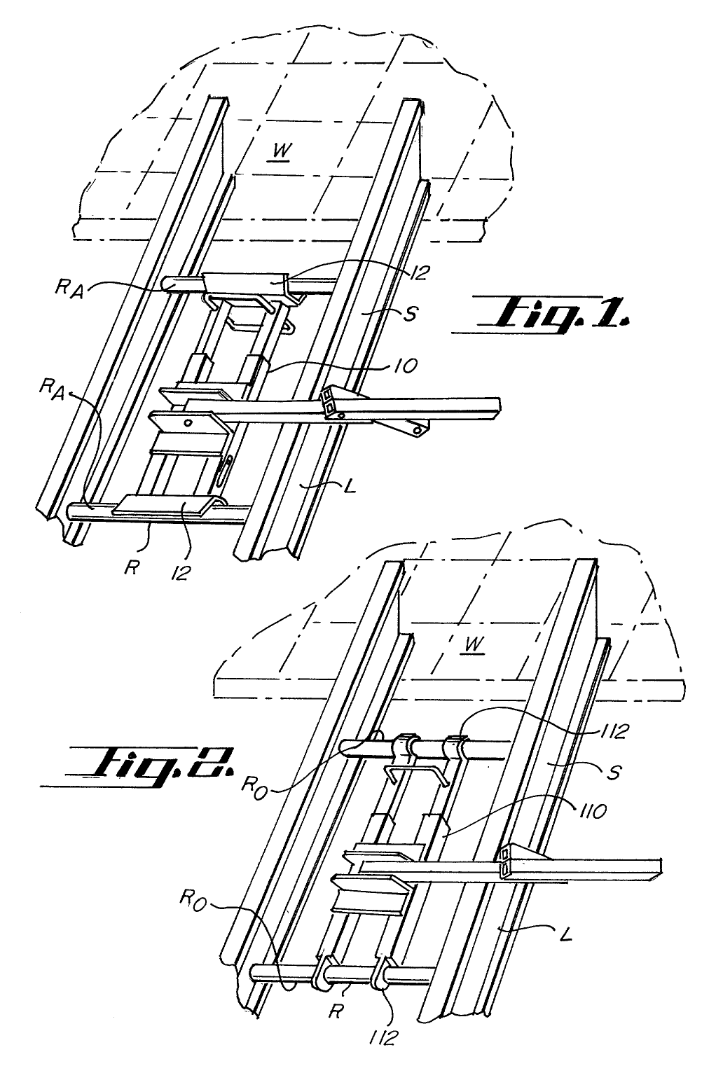

FIGS. 1 and 2 show a ladder L leaning against a wall W. The ladder L has rungs R and side rails S.

A first embodiment of the apparatus 10 of the present invention is shown attached to the ladder L in FIG. 1. In the first embodiment, the apparatus 10 attaches between the rungs R by means of engagement members 12 that contact adjacent sides RA of the rungs R.

A second embodiment 110 of the present invention is shown attached to the ladder in FIG. 2. In the second embodiment, the apparatus 110 attaches between the rungs R by means of engagement members 112 that contact non-adjacent sides RO of the rungs R.

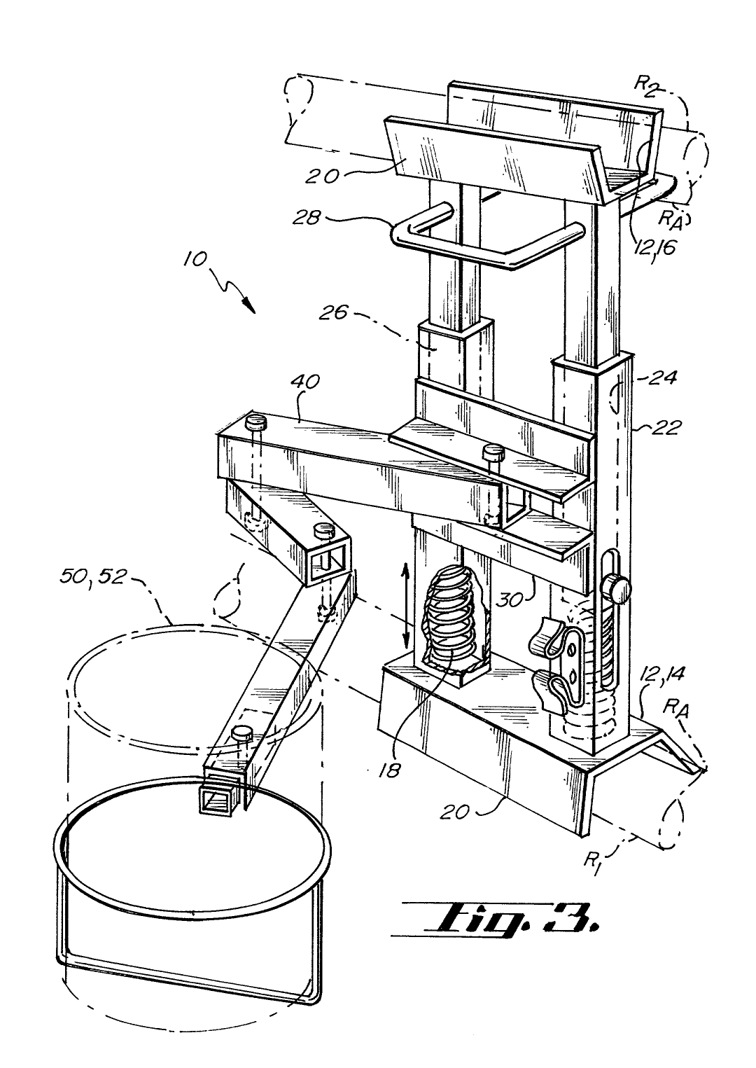

Details of the first embodiment 10 are shown in FIG. 3. The apparatus 10 further comprises a first engagement member 14 adapted to engage ladder rung R1 and a second engagement member 16 adapted to engage adjacent rung R2. The apparatus 10 also comprises a spring 18 biasing the first engagement member 14 and the second engagement member 16 against the rungs R1, R2.

The first engagement member 14 and second engagement member 16 preferably comprise U-shaped channels 20 adapted to contact the ladder rungs on the adjacent sides RA. Most preferably, the first engagement member 14 further comprises a first elongate member 22 having a central core 24, and the second engagement member further comprises a second elongate member 26 slidingly engaged within the first elongate member 22. The spring 18 is contained within the first elongate member 22, and the spring tension biases the members 22, 26 away from each other as shown by the arrow.

It will be seen that, to attach the apparatus 10 to the rungs R, it is merely necessary to compress the spring 18, by pushing the first engagement member 14 toward the second engagement member 16. One of the members 14, 16 is then slid against a rung, and the spring tension is released, allowing the other member 14, 16 to slide against the adjacent rung. To facilitate this operation, one of the members 14, 16 may have a handle 28.

Only one each of the members 22, 26 is required. However, to allow the most secure attachment, a plurality of the members 22, 26 may be used, as is shown in the Figures, and a corresponding number of springs 18 may be employed.

Turning to FIG. 4, details of the second embodiment are illustrated. The apparatus 110 further comprises a first engagement member 114 adapted to engage ladder rung R1 and a second engagement member 116 adapted to engage adjacent rung R2. The apparatus 110 also comprises a spring 118 biasing the first engagement member 114 and the second engagement member 116 against the rungs R1, R2.

The first engagement member 114 and second engagement member 116 preferably comprise hooks 120 adapted to contact the ladder rungs on the opposite sides RO. Most preferably, the first engagement member 114 further comprises a first elongate member 122 having a central core 124, and the second engagement member further comprises a second elongate member 126 slidingly engaged within the first elongate member 122. The spring 118 is contained within the first elongate member 122, and the spring tension biases the members 122, 126 toward each other as shown by the arrows.

It will be seen that, to attach the apparatus 110 to the rungs R, it is merely necessary to expand the spring 118, by hooking one of the members 114, 116 over a rung, then pulling the first engagement member 114 away from the second engagement member 116. The spring tension is released, allowing the other member 114, 116 to slide over the adjacent rung. To facilitate this operation, a handle 128 may be attached to one of the members 114, 116.

Only one each of the members 122, 126 is required. However, to allow the most secure attachment, a plurality of the members 122, 126 may be used, as is shown in the Figures, and a corresponding number of springs 118 may be employed.

In each embodiment a frame 30 may be placed between the first engagement member 14, 114 and the second engagement member 16, 116. If more than one first elongate member 22, 122 is used, the frame 30 serves to connect the first elongate members together for parallel movement. The frame may also be used to assist in pulling the members 114, 116 apart in the second embodiment.

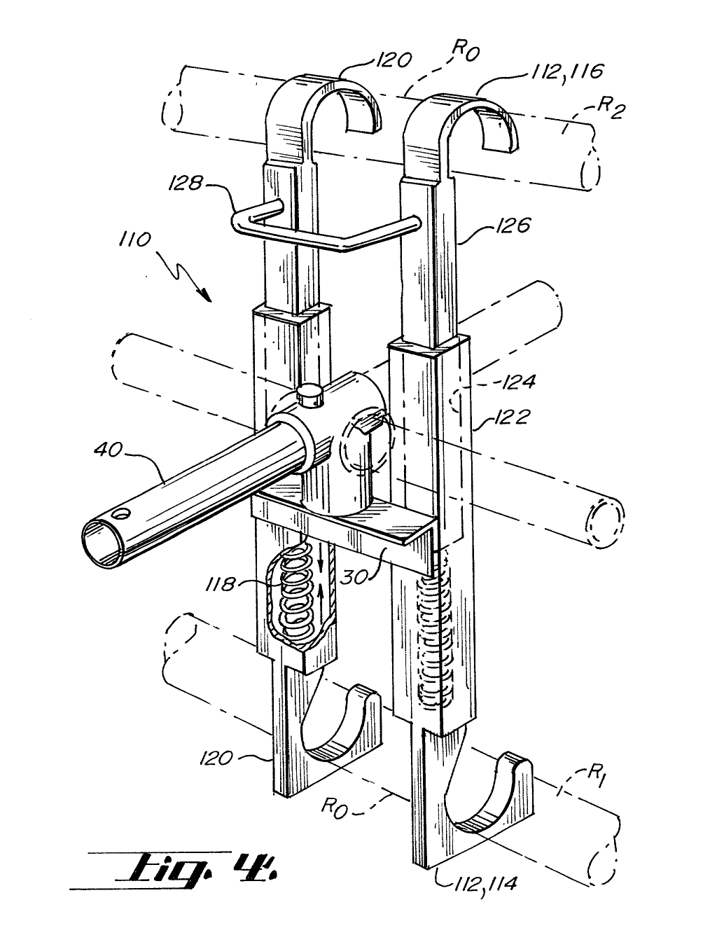

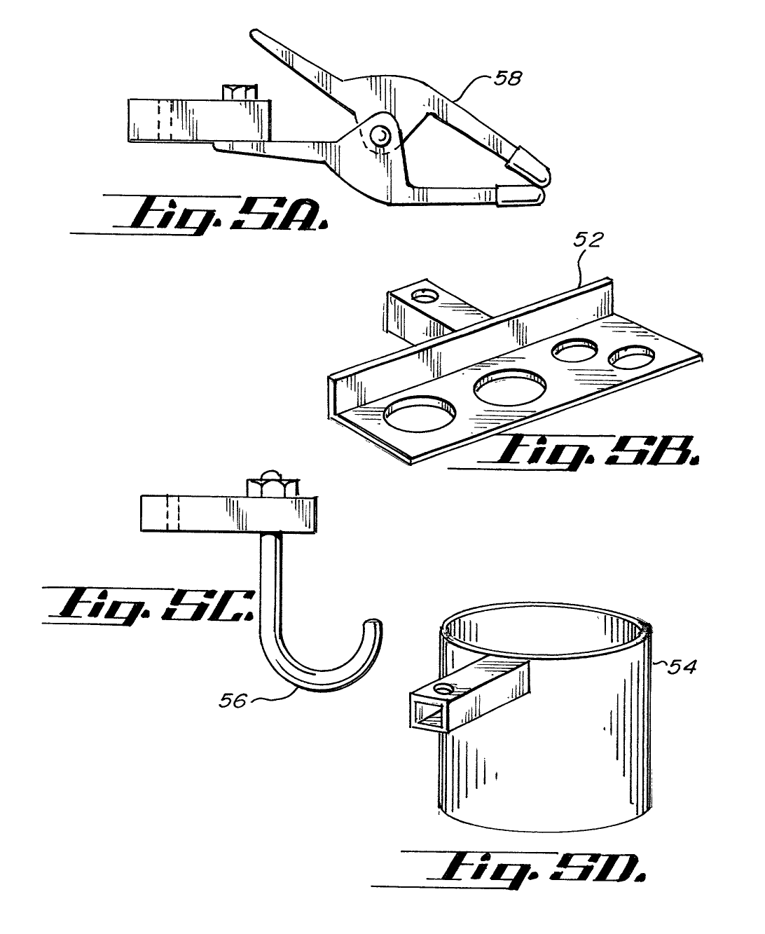

An arm 40 may be pivotally attached to the frame 30. A variety of interchangeable accessories 50 may be attached to the arm 40. FIGS. 5a-5d illustrate some of these accessories: a tool holder 52; a bucket 54, a hook 56, or a gripper 58. Other accessories are possible.

The present invention may be embodied in other specific forms without departing from the spirit or essential attributes thereof, and it is therefore desired that the present embodiment be considered in all respects as illustrative and not restrictive, reference being made to the appended claims rather than to the foregoing description to indicate the scope of the invention.

What is claimed:

1. Apparatus for attachment to the rungs of a ladder for securely holding a bucket and other accessories, the apparatus being readily detachable from the ladder rungs for movement along the ladder, the apparatus comprising:
a) a first engagement member adapted to engage a ladder rung;
b) a second engagement member adapted to engage an adjacent ladder rung; and
c) a spring biasing the first engagement member and second engagement member against the respective ladder rungs.

2. The apparatus of claim 1, wherein the first engagement member and second engagement member each further comprise a substantially U-shaped channel adapted to contact the ladder rungs on adjacent sides of the ladder rungs.

3. The apparatus of claim 1, wherein the first engagement member and second engagement member each further comprise hooks adapted to contact the ladder rungs on nonadjacent sides of the ladder rungs.

4. The apparatus of claim 1, wherein the first engagement member further comprises a first elongate member having a central core and wherein the second engagment member further comprises a second elongate member slidingly engaged within the first elongate member.

5. The apparatus of claim 4, wherein the spring is contained within the first elongate member.

6. The apparatus of claim 1, further comprising a frame between the first engagement member and the second engagment member and an arm pivotally attached to the frame.

7. The apparatus of claim 1, wherein the first engagement member further comprises a plurality of elongate members each having a central core and wherein the second engagement member further comprises a plurality of second elongage members each slidingly engaged with one of the plurality of first elongate members.

8. The apparatus of claim 6, further comprising accessories attachable to the arm.

9. The apparatus of claim 8, wherein the accessories further comprise: a bucket holder, a bucket, a hook, and a gripper.

10. Apparatus for attachment to the rungs of a ladder for securely holding a bucket and other accessories, the apparatus being readily detachable from the ladder rungs for movement along the ladder, the apparatus comprising:
a) a first engagement member adapted to engage a ladder rung;
b) a second engagement member adapted to engage an adjacent ladder rung; and
c) a spring biasing the first engagement member and second engagement member against the respective ladder rungs
wherein the first engagement member and second engagement member each further comprise a substantially U-shaped channel adapted to contact the ladder rungs on adjacent sides of the ladder rungs.

11. The apparatus of claim 10, wherein the first engagement member further comprises a first elongate member having a central core and wherein the second engagment member further comprises a second elongate member slidingly engaged within the first elongate member.

12. The apparatus of claim 11, wherein the spring is contained within the first elongate member.

13. The apparatus of claim 10, further comprising a frame between the first engagement member and the second engagment member and an arm pivotally attached to the frame.

14. The apparatus of claim 10, wherein the first engagement member further comprises a plurality of elongate members each having a central core and wherein the second engagement member further comprises a plurality of second elongage members each slidingly engaged with one of the plurality of first elongate members.

15. The apparatus of claim 13, further comprising accessories attachable to the arm.

16. The apparatus of claim 15, wherein the accessories further comprise: a bucket holder, a bucket, a hook, and a gripper.

17. Apparatus for attachment to the rungs of a ladder for securely holding a bucket and other accessories, the apparatus being readily detachable from the ladder rungs for movement along the ladder, the apparatus comprising:
a) a first engagement member adapted to engage a ladder rung;
b) a second engagement member adapted to engage an adjacent ladder rung; and
c) a spring biasing the first engagement member and second engagement member against the respective ladder rungs
wherein the first engagement member and second engagement member each further comprise hooks adapted to contact the ladder rungs on non-adjacent sides of the ladder rungs.

18. The apparatus of claim 17, wherein the first engagement member further comprises a first elongate member having a central core and wherein the second engagment member further comprises a second elongate member slidingly engaged within the first elongate member.

19. The apparatus of claim 18, wherein the spring is contained within the first elongate member.

20. The apparatus of claim 17, further comprising a frame between the first engagement member and the second engagment member and an arm pivotally attached to the frame.

21. The apparatus of claim 17, wherein the first engagement member further comprises a plurality of elongate members each having a central core and wherein the second engagement member further comprises a plurality of second elongage members each slidingly engaged with one of the plurality of first elongate members.

22. The apparatus of claim 20, further comprising accessories attachable to the arm.

23. The apparatus of claim 22, wherein the accessories further comprise: a bucket holder, a bucket, a hook, and a gripper.
